(19) United States
(12) Patent Application Publication
(10) Pub. No.: US 2015/0364245 A1
(43) Pub. Date: Dec. 17, 2015

(54) COIL COMPONENT AND POWER SUPPLY UNIT INCLUDING THE SAME

(71) Applicant: Samsung Electro-Mechanics Co., Ltd., Suwon-Si (KR)

(72) Inventors: Se Hoon JANG, Suwon-Si (KR); Heung Gyoon CHOI, Suwon-Si (KR); Duck Jin AN, Suwon-Si (KR); Geun Young PARK, Suwon-Si (KR); Jae Gen EOM, Suwon-Si (KR)

(73) Assignee: Samsung Electro-Mechanics Co., Ltd., Suwon-Si (KR)

(21) Appl. No.: 14/698,095

(22) Filed: Apr. 28, 2015

(30) Foreign Application Priority Data
Jun. 16, 2014 (KR) 10-2014-0072786
Dec. 8, 2014 (KR) 10-2014-0175015

(51) Int. Cl. H01F 27/28; H01F 27/32

(52) U.S. Cl. CPC H01F 27/2823; H01F 27/324

(57) ABSTRACT

The coil component includes a core, first and second coil parts coupled to the core while being stacked with each other, and an insulating member accommodating the second coil part therein. In addition, the second coil part is formed of a flat-type wire.

### CROSS-REFERENCE TO RELATED APPLICATION

This application claims the priority and benefit of Korean Patent Application Nos. 10-2014-0072786 filed on Jun. 16, 2014, and 10-2014-0175015 filed on Dec. 8, 2014, with the Korean Intellectual Property Office, the disclosure of which is incorporated herein by reference.

### BACKGROUND

The present disclosure relates to a coil component and a power supply unit including the same.

A coil component includes a core, a bobbin, wirings, and the like. Although the number of coil components may be sma a manufacturing process of the coil component may be complicated, since a certain amount of space for creepage distance should be secured between such wirings and a core or insulating tape should be wound around a winding of a primary coil and a winding of a secondary coil in order to satisfy safety standards.

In addition, in a case of winding such coils, a problem in which turns or winding positions of the coils are not constant due to variations in manufacturing by human workers may exist.

Therefore, the development of a coil component having a novel structure is required to allow for the miniaturization thereof and simplify a manufacturing process of such a coil component.

### SUMMARY

An aspect of the present disclosure may provide a miniaturized coil component having improved insulation characteristics between a first coil part and a second coil part, and a power supply unit including the same.

According to an aspect of the present disclosure, a coil component may include a core, first and second coil parts coupled to the core while being stacked with each other, and an insulating member accommodating the second coil part therein.

The second coil part may be formed of a flat-type wire.

According to another aspect of the present disclosure, a coil component may include a first coil part including a multilayer substrate, a second coil part including a flat-type wire and stacked with the first coil part, a core coupled to the first and second coil parts, and an insulating member securing insulation between the second coil part and the core.

According to another aspect of the present disclosure, a coil component may include a first coil part including a multilayer substrate, a second coil part including a flat-type wire and stacked with the first coil part, a core coupled to the first and second coil parts, and an insulating member securing insulation between the second coil part and the first coil part.

According to another aspect of the present disclosure, a power supply unit may include a coil component including first and second coil parts coupled to a core while being stacked with each other and an insulating member accommodating the second coil part therein, a main board on which the coil component is mounted, and at least one primary electronic component and at least one secondary electronic component mounted on the main board.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a perspective view schematically illustrating a coil component according to an exemplary embodiment in the present disclosure;

FIG. 2 is an exploded perspective view schematically illustrating the coil component of FIG. 1;

FIG. 3 is an enlarged perspective view of a second coil part of FIG. 2;

FIG. 4 is a plan view only illustrating a flat-type wire and a multilayer substrate of FIG. 2;

FIG. 5 is a plan view only illustrating a flat-type wire and a multilayer substrate according to another exemplary embodiment in the present disclosure;

FIG. 6 is an exploded perspective view illustrating the flat-type wire and the multilayer substrate of FIG. 5; and

FIG. 7 is a perspective view schematically illustrating a state in which the coil component according to the exemplary embodiment in the present disclosure is mounted on a main board.

### DETAILED DESCRIPTION

Hereinafter, embodiments in the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

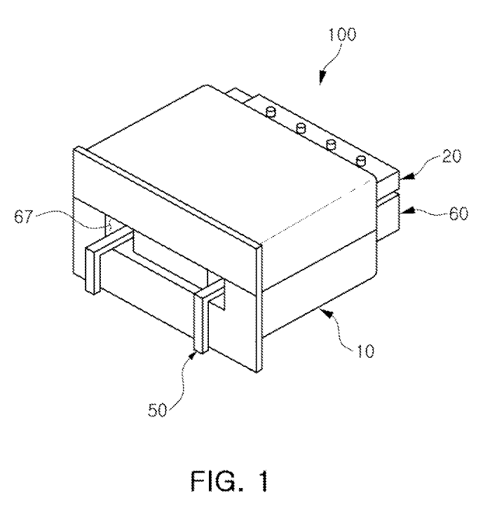

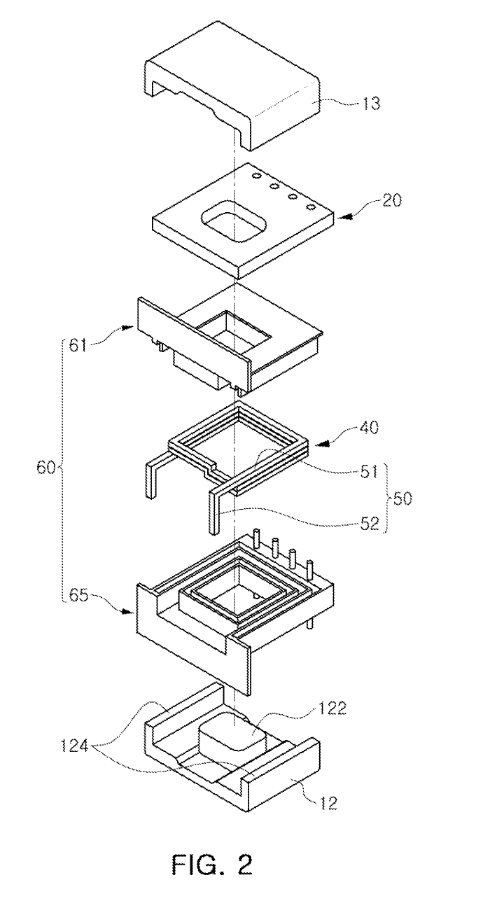

FIG. 1 is a perspective view schematically illustrating a coil component according to an exemplary embodiment in the present disclosure; and FIG. 2 is an exploded perspective view schematically illustrating the coil component of FIG. 1.

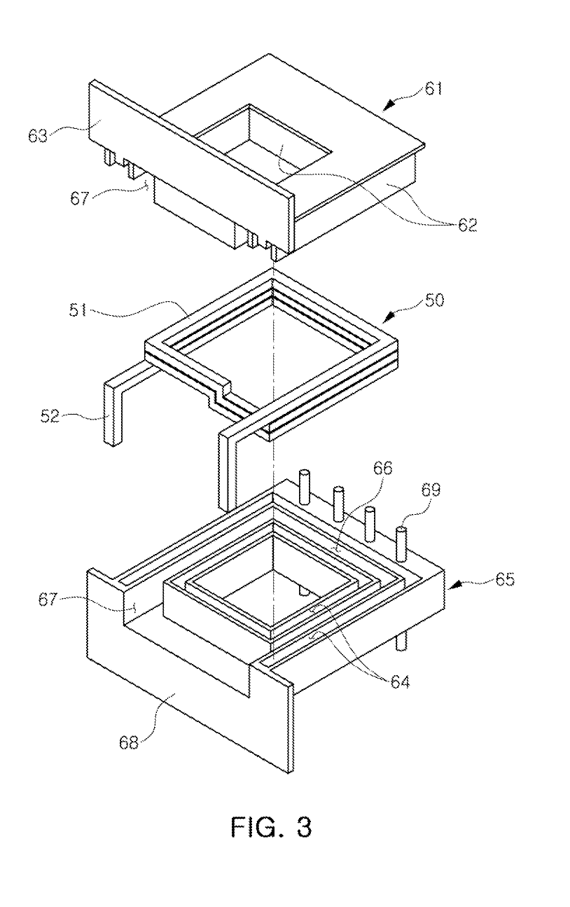

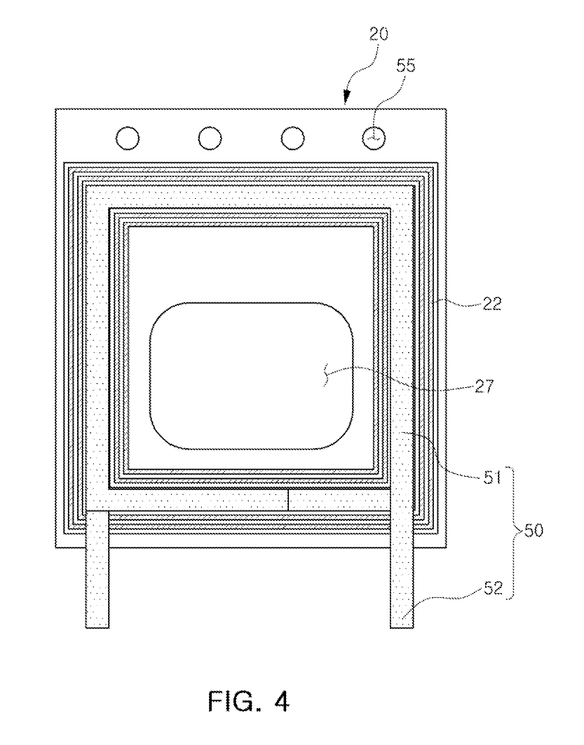

In addition, FIG. 3 is an enlarged perspective view of a second coil part of FIG. 2; and FIG. 4 is a plan view only illustrating a flat-type wire and a multilayer substrate in FIG.

2.

Referring to FIGS. 1 to 2, a coil component 100 according to the present exemplary embodiment may include a core 10, a first coil part 20, a second coil part 40, and an insulating member 60.

The core 10 may be an EE-shaped core having a middle leg 122 and outer legs 124, and first and second core parts 12 and 13 corresponding to each other maybe configured in pair to complete the core 10.

The core 10 according to the present exemplary embodiment may be coupled to the first and second coil parts 20 and 40 while having the middle leg 122 penetrating through the centers of the first and second coil parts 20 and 40.

Meanwhile, although the ES-shaped core of which a cross section has an E shape has been illustrated in the present exemplary embodiment, the present disclosure is not particularly limited thereto. For example, the core 10 may be formed to have various shapes, such as an EI shape, a UU shape, a UI shape, and the like.

In addition, the core 10 may be formed of a magnetic material, and may be formed of a Mn—Zn based ferrite having higher permeability, lower loss, higher saturation magnetic flux density, higher stability, and lower production costs, as compared with other materials. However, in the exemplary embodiment in the present disclosure, a shape or a material of the core 10 is not limited.

The first coil part 20 may be formed of a multilayer substrate in which at least one pattern layer including a conductive pattern 22 (See FIG. 4) is stacked. Here, the conductive pattern 22 may be formed of a coil pattern having a spiral shape . For example, the conductive pattern 22 may be an inductor pattern having a predetermined turn.

An insulating layer may be interposed between the pattern layers. Therefore, a printed circuit board (PCB) may be used as the multilayer substrate according to the present exemplary embodiment. However, the present disclosure is not limited thereto and may have various configurations. That is, any substrate including the conductive pattern 22 formed on the insulating layer, such as a flexible substrate, a ceramic substrate, a glass substrate, or the like, may be used as the multilayer substrate.

In addition, in a case in which the pattern layer is implemented by a plurality of layers, penetration vias (not illustrated) for electrically connecting the plurality of pattern layers to each other may be formed in the multilayer substrate. However, the present disclosure is not limited thereto, and may have various configurations. For example, the pattern layers may be connected to each other through a side surface of the multilayer substrate.

Meanwhile, the first coil part 20 according to the present exemplary embodiment may be used as a primary coil, and the second coil part 40 according to the present exemplary embodiment may be used as a secondary coil. However, the present disclosure is not limited thereto, and may have various configurations. For example, the second coil part 40 to be described below may be used as the primary coil.

The second coil part 40 may include a flat-type wire 50 and may be accommodated in the insulating member 60.

The flat-type wire 50 (or rectangular Wire, edgewise coil), a wire formed in a coil form by winding a flat-type wire formed of a metal or a flat-type copper wire, may be a conductive flat-type wire entirely formed of a conductor or an insulating flat-type wire having an insulating coating formed on an outer surface thereof.

The flat-type wire 50 may be divided into a portion 51 (See FIG. 3) (hereinafter, referred to as a winding portion 51 wound in a coil form and lead portions 52 extended from both ends of the winding portion 51.

In addition, as illustrated in FIG. 4, the winding portion 51 of the flat-type wire 50 may be formed in a shape corresponding to that of the conductive pattern 22 of the first coil part 20. That is, when the first and second coil parts 20 and 40 are coupled to each other, the conductive pattern 22 of the first coil part 20 and the flat-type wire 50 of the second coil part 40 may be disposed to have the concentricity and may be disposed to form contours corresponding to each other.

In the present exemplary embodiment, the winding portion 51 of the flat-type wire 50 may be formed in a rectangular shape. Since the shape of the winding portion 51 of the flat-type wire 50 corresponds to that of the conductive pattern 22 of the first coil part 20, in a case in which the conductive pattern 22 of the first coil part 20 is formed in another shape (for example, circular shape), the shape of the winding portion 51 of the flat-type wire 50 may also be changed.

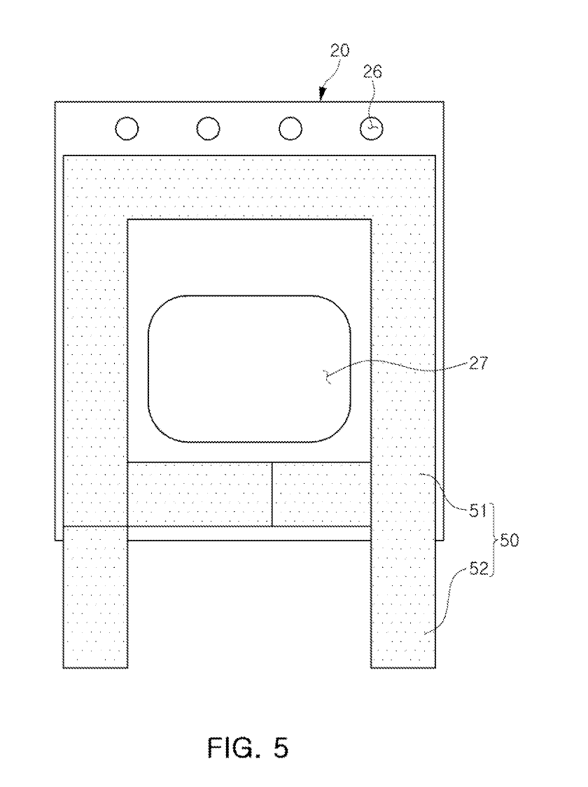

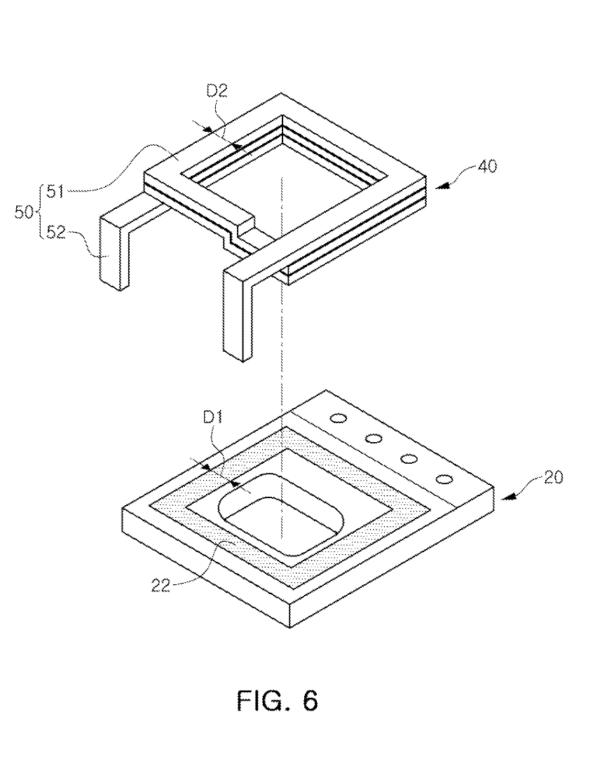

Meanwhile, the flat-type wire 50 according to the present exemplary embodiment is not limited to have the shape illustrated in FIG. 4. For example, the shape of the flat-type wire 50 may be changed as illustrated in FIGS. 5 and 6.

FIG. 5 is a plan view only illustrating a flat-type wire and a multilayer substrate according to another exemplary embodiment in the present disclosure; and FIG. 6 is an exploded perspective view illustrating the flat-type wire and the multilayer substrate of FIG. 5. In FIGS. 5 and 6, an example in which a flat-type wire 50 is formed at a width D2 corresponding to an entire width D1 of coil patterns formed by the conductive pattern 22 of the first coil part 20 is illustrated.

In this case, the flat-type wire 50, the second coil part 40, maybe disposed to face the conductive pattern 22 of the first coil part 20 at a maximum area. Therefore, a coupling coefficient between primary and secondary sides maybe further increased, such that a leakage inductance may be significantly decreased.

The insulating member 60 may protect the flat-type wire 50 from the outside while accommodating the flat-type wire 50 therein. In addition, the insulating member 60 may secure insulation between the flat-type wire 50 and the core 10 while securing insulation between the flat-type wire 50 and the conductive pattern 22 of the first coil part 20.

Referring to FIG. 3, the entire winding portion 51 of the flat-type wire 50 wound in a coil form may be accommodated in the insulating member 60, and only the lead portions 52 of the flat-type wire 50 maybe exposed to the outside of the insulating member 60.

The insulating member 60 may be formed of an insulating material such as a resin, or the like, and may include a first insulating member 61 and a second insulating member 65.

The first insulating member 61 and the second insulating member 65 maybe coupled to each other to complete the insulating member 60, and may accommodate the flat-type wire 50 therein.

Therefore, the first insulating member 61 and the second insulating member 65 may have a space 66 in which the flat-type wire 50 is accommodated. In more detail, when the first insulating member 61 and the second insulating member 65 are coupled to each other, an accommodation space 66 having a shape corresponding to that of the flat-type wire 50 maybe formed in the first insulating member 61 and the second insulating member 65, and an opening 67 through which the lead portions 52 of the flat-type wire 50 are led may be formed in one surface of the insulating member 60.

The first insulating member 61 and the second insulating member 65 may be firmly insertedly-coupled to each other in order to secure insulation between the flat-type wire 50 accommodated therein and the outside (for example, the first coil part, the core, a main board, and the like)

For example, the first insulating member 61 may have fitting protrusions 62 formed thereon in a sidewall form, and the second insulating member 65 may have fitting grooves 64 into which the fitting protrusions 62 are inserted, such that the first and second insulating members 61 and 62 may be firmly coupled to each other through fitting-coupling therebetween.

Here, the fitting protrusions 62 may be continuously formed along side surfaces of the insulating member 60 other than the opening 67. Likewise, the fitting grooves 64 may also be formed along the side surfaces of the insulating member 60 other than the opening 67.

In addition, the first and second insulating members 61 and 65 may have flange parts 63 and 68 extended outwardly from a portion in which the opening 67 is formed, respectively.

The flange parts 63 and 68 may be provided in order to secure insulation between the lead portions 52 of the flat-type wire 50 and the core 10. Therefore, extension widths, extension directions, and the like, of the flange parts 63 and 68 may be defined depending on a size and a position of the core 10, a size and a position of the flat-type wire 50, and the like.

In addition, the second insulating member 65 according to the present exemplary embodiment may include a plurality of terminal pins 69.

The terminal pins 69 may be provided in order to electrically connect the first coil part 20, described above, and a main board 200 (See FIG. 6) to each other. Therefore, the terminal pins 69 may be provided in the insulating member 60 accommodating the second coil part 40 therein, but may perform a function (for example, a primary side) of the first coil part 20.

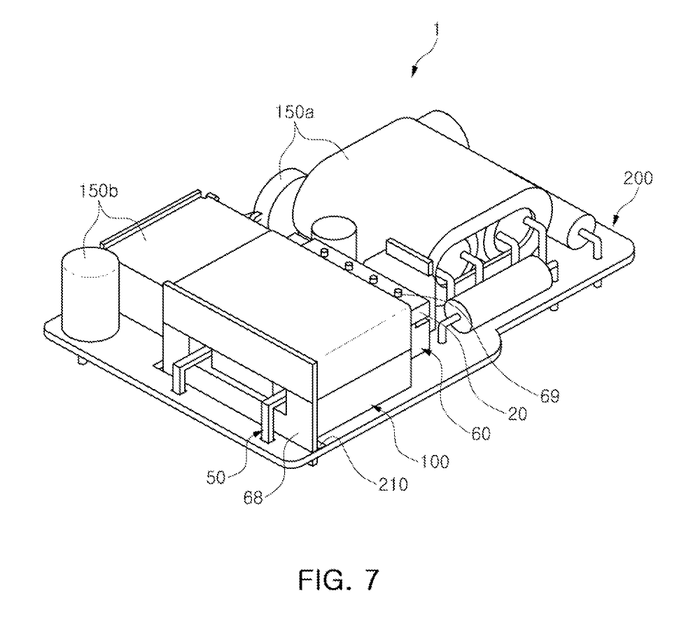

The terminal pins 69 may be disposed to vertically penetrate through the second insulating member 65 in a side opposite to the opening 67 in the second insulating member 65, such that portions of the terminal pins 69 are exposed to an upper portion of the second insulating member 65. Here, portions of the terminal pins 69 exposed to an upper portion of the second insulating member 65 may be bonded to the first coil part 20, and portions of the terminal pins 69 exposed to a lower portion of the second insulating member 65 may be bonded to the main board 200 (See FIG. 7).

Meanwhile, although a case in which the terminal pins 69 are provided in the second insulating member 65 has been described by way of example in the present exemplary embodiment, the present disclosure is not limited thereto, and may have various configurations. For example, the terminal pins 69 may also be configured to be fastened to the first coil part 20. In addition, the terminal pins may also be fastened to the main board or the first coil part, not to the insulating member, and a separate terminal member to which the terminal pins are fastened may be added.

In addition, a case in which the insulating member 60 is divided into the first insulating member 61 and the second insulating member 65 and the first insulating member 61 and the second insulating member 65 are coupled to each other to complete the insulating member 60 has been described by way of example in the present exemplary embodiment. However, the present disclosure is not limited thereto, and may have various configurations. For example, an insulating member in which the flat-type wire 50 is buried may be formed through injection-molding in a state in which the flat-type wire 50 is disposed in a mold.

In addition, although a case in which the first coil part 20 is disposed above the second coil part 40 has been described by way of example in the present exemplary embodiment, positions of the first and second coil parts 20 and 40 may be exchanged with each other, if necessary.

FIG. 7 is a perspective view schematically illustrating a state in which the coil component according to the exemplary embodiment in the present disclosure is mounted on a main board.

Referring to FIG. 7, the coil component 100 according to the present exemplary embodiment may be mounted on the main board 200 to complete a power supply unit 1.

Here, the flange part 68 formed in the insulating member 60 of the coil component 100 may be inserted into a slit 210 formed in the main board 200.

This maybe a configuration for securing insulation between a primary circuit of the main board 200 and the flat-type wire 50, the secondary coil of the coil component 100.

Primary electronic components 150a and secondary electronic components 150b may be mounted together on the main board 200. Therefore, in this case, an insulating distance and a creepage distance need to be secured between the primary electronic components 150a and the secondary electronic components 150b.

In a case in which the coil component 100 according to the present exemplary embodiment is mounted on the main board 200, a distance between a portion to which the flat-type wire 50, a secondary side, is bonded and a portion to which the terminal pins 69, a primary side, are bonded may correspond to a width of the coil component 100. However, since the coil component 100 according to the present exemplary embodiment has a relatively small size, it may be difficult to secure an insulating distance or a creepage distance between the primary side and the secondary side only with the above-mentioned distance.

Therefore, in the power supply unit 1 according to the present exemplary embodiment, the slit 210 may be formed in the main board 200, and the coil component 100 may be mounted on the main board 200 so that the flange part 68 of the insulating member 60 is inserted into the slit 210. Therefore, even though the coil component 100 has a relatively small size, the creepage distance between the primary side and the secondary side may be easily secured.

In the coil component 100 according to the present exemplary embodiment configured as described above, the first coil part 20 maybe completed through a PCB manufacturing process, and the flat-type wire 50 and the insulating member 60 may be coupled to each other to complete the second coil part 40. In addition, the first coil part 20, the second coil part 40, and the core 10 may be coupled to each other while being stacked with each other, thereby completing the coil component 100.

Therefore, since a wire having a conducting wire form is not wound around a bobbin unlike in the case of the related art, the coil component 100 may be very easily manufactured, and a manufacturing cost of the coil component 100 may be decreased.

In addition, since the flat-type wire 50 is used as the second coil part 40, the conductive pattern of the primary side may face the flat-type wire of the secondary side at a wide area, such that a leakage inductance may be significantly decreased.

As set forth above, in the coil component and the power supply unit including the same according to the exemplary embodiments in the present disclosure, insulation between the first coil part and the second coil part maybe easily secured even though the coil component has a relatively small size.

In addition, a bobbin according to the related art, a process of winding the coil around the bobbin, and the like, may be omitted, such that the coil component maybe easily manufactured and manufacturing costs for the coil component may be decreased.

Further, since the flat-type wire is used as the second coil part and is coupled to the conductive pattern of the first coil part to face the conductive pattern of the first coil part at a wide area, a leakage inductance may be significantly decreased.

While exemplary embodiments have been shown and described above, it will be apparent to those skilled in the art that modifications and variations could be made without departing from the scope of the present invention as defined by the appended claims.

What is claimed is:

1. A coil component comprising:
a core;
first and second coil parts coupled to the core while being stacked with each other; and
an insulating member accommodating the second coil part.

2. The coil component of claim 1, wherein the second coil part is formed of a flat-type wire.

3. The coil component of claim 2, wherein the first coil part includes a multilayer substrate in which at least one pattern layer including a conductive pattern formed in a coil shape stacked.

4. The coil component of claim 3, wherein the flat-type wire has a winding portion formed in a shape corresponding to a shape of the conductive pattern of the first coil part.

5. The coil component of claim 3, wherein the flat-type wire has a width corresponding to an overall width of coil patterns formed by the conductive pattern of the first coil part.

6. The coil component of claim 1, wherein the insulating member includes a first insulating member and a second insulating member, and the second coil part is accommodated in an internal space formed by coupling the first insulating member and the second insulating member to each other.

7. The coil component of claim 6, wherein the first and second insulating members of the insulating member are formed integrally with each other by fitting-coupling.

8. The coil component of claim 6, wherein the first insulating member has fitting protrusions formed in a sidewall form, and the second insulating member has fitting grooves, the fitting protrusions being inserted into the fitting grooves.

9. The coil component of claim 8, wherein the insulating member has an opening formed in one side of the insulating member through which lead portions of the second coil part are exposed, and the fitting protrusions and the fitting grooves are formed along side surfaces of the insulating member other than the opening.

10. The coil component of claim 9, wherein the insulating member includes a flange part extended outwardly from a portion in which an opening is disposed.

11. The coil component of claim 10, wherein the flange part is disposed between the core and a lead wire of the second coil part to secure an insulating distance between the core and the lead wire of the second coil part.

12. The coil component of claim 10, wherein the flange part is disposed between the first coil part and the lead wire of the second coil part to secure an insulating distance between the first coil part and the lead wire of the second coil part.

13. The coil component of claim 10, wherein at least a portion of the flange part is disposed to be inserted into a main board while penetrating through the main board when the coil component is mounted on the main board.

14. The coil component of claim 1, further comprising at least one terminal pin fastened to the insulating member while penetrating through the insulating member.

15. The coil component of claim 14, wherein the terminal pin has one end electrically connected to the first coil part and the other end electrically connected to the main board.

16. A coil component comprising:
a first coil part including a multilayer substrate;
a second coil part including a flat-type wire and stacked with the first coil part;
a core coupled to the first and second coil parts; and
an insulating member securing insulation between the second coil part and the core.

17. A coil component comprising:
a first coil part including a multilayer substrate;
a second coil part including a flat-type wire and stacked with the first coil part;
a core coupled to the first and second coil parts; and
an insulating member securing insulation between the second coil part and the first coil part.

18. A power supply unit comprising:
a coil component including first and second coil parts stacked with each other and coupled to a core and an insulating member accommodating the second coil part inside the insulating member;
a main board on which the coil component is mounted; and
at least one primary electronic component and at least one secondary electronic component mounted on the main board.
